(19) United States
(12) Patent Application Publication
(10) Pub. No.: US 2014/0116938 A1
(43) Pub. Date: May 1, 2014

(54) Chemical Treatment Method and Apparatus to Increase Wastewater Bioreactor Processing Capacity While Producing Class A Biosolids

(71) Applicant: Marcus George Theodore, Salt Lake City, UT (US)

(72) Inventor: Marcus George Theodore, Salt Lake City, UT (US)

(21) Appl. No.: 13/660,443

(22) Filed: Oct. 25, 2012

(51) Int. Cl. C02F 9/00

(52) U.S. Cl. CPC C02F 9/00
USPC 210/609; 210/205

(57) ABSTRACT

A chemical/mechanical sludge dewatering treatment method and apparatus injecting SO₂ into wastewater inflow streams and/or conventional process liquid streams containing suspended solids at a pH and dwell time to generate sufficient sulfurous acid with free SO₂, sulfites and bisulfites to disinfect and self-agglomerate the suspended solids, acid leach heavy metals contained in and on the suspended solids into solution for subsequent separation, condition the suspended solids for subsequent chemical dewatering shedding water upon separation and drying, and mechanically separating and disposing of any solids from its chemically treated liquid fraction to create a Class A biosolid drying to less than 10% by weight water content.

### BACKGROUND OF THE INVENTION

1. Field

This invention relates to wastewater treatment methods to produce Class A Biosolids. More particularly, it relates to a chemical treatment method and apparatus, which increases a wastewater treatment facility's bioreactor processing capacity while producing Class A Biosolids.

2. State of the Art

Most large municipal systems employ a series of settling ponds sequentially concentrating the solids contained in wastewater either with or without polymers for separation from liquids via mechanical separation means, such as belt presses. To produce a clean effluent that can be safely discharged to watercourses, wastewater treatment operations use distinct stages of treatment to remove harmful contaminants. Preliminary wastewater treatment usually involves gravity sedimentation of screened wastewater to remove settled solids. Secondary wastewater treatment is accomplished through a biological process, removing biodegradable material. This treatment process uses microorganisms to consume dissolved and suspended organic matter, producing carbon dioxide and other by-products. The removal capacity of these secondary bioreactors is dependent upon the influent suspended solids and dissolved solids and nutrient concentration loads placed on them. Tertiary or advanced treatment is used when extremely high-quality effluent is required with reduced solid residuals collected through tertiary treatment consisting mainly of chemicals added to clean the final effluent, which are reclaimed before discharge, and therefore not incorporated into bio-solids.

Wastewater treatment plants employ different types of bioreactors using microbes and bacteria to reduce BOD, nitrogen and phosphorous compounds contained in wastewater influent, and separate the suspended solids into Class A and Class B Biosolids. To ensure that biosolids applied to the land do not threaten public health, the U.S. Environmental Protection Agency (EPA) created the 40 CFR Part 503 Rule. It categorizes biosolids as Class A or B, depending on the levels of pathogenic organisms in the material, and describes specific processes to reduce pathogens to these levels.

The 503 rule also requires heavy metals reduction and “vector attraction reduction” (VAR)—reducing the potential for spreading of infectious disease agents by vectors (i.e., flies, rodents and birds)—and spells out specific management practices, monitoring frequencies, record keeping and reporting requirements. Incineration of biosolids is also covered in the regulation.

As stated in www.water.siemens.com/en/applications/water and wastewater . . . , Class A biosolids contain minute levels of pathogens. To achieve Class A certification, biosolids must undergo heating, composting, digestion or increased pH that reduces pathogens to below detectable levels. Some treatment processes change the composition of the biosolids to a pellet or granular substance, which can be used as a commercial fertilizer. Once these goals are achieved, Class A biosolids can be land applied without any pathogen-related restrictions at the site. Class A biosolids can be bagged and marketed to the public for application to lawns and gardens.

Class B biosolids have less stringent standards for treatment and contain small but compliant amounts of bacteria. Class B requirements ensure that pathogens in biosolids have been reduced to levels that protect public health and the environment and include certain restrictions for crop harvesting, grazing animals and public contact for all forms of Class B biosolids. Class B biosolids similarly undergo heating, composting, digestion or increased pH processes before leaving a wastewater treatment plant. This semi-solid material can receive further treatment when exposed to the natural environment as a fertilizer, where heat, wind and soil microbes naturally stabilize the biosolids.

The biosolids rule spells out specific treatment processes and treatment conditions that must be met for both A or B classifications.

Technologies that can meet Class A standards include thermal treatment methods like composting, heat drying, heat treatment, thermophilic (heat generating) aerobic digestion and pasteurization. Class A technologies are known as PFRP—Processes that can Further Reduce Pathogens. The technologies must process the biosolids for a specific length of time at a specific temperature.

Composting.

This is an environmentally friendly way to recycle the nutrients and organic matter found in wastewater solids. Composting systems turn wastewater biosolids, sawdust, yard waste and wood chips into high-quality compost. As the material decomposes, oxygen filters through the compost site, releasing water, heat and carbon dioxide. This process helps dry the organic material, while the generated heat increases the rate of decomposition and kills pathogens.

Heat Drying.

This process applies direct or indirect heat to reduce the moisture in biosolids. It eliminates pathogens, reduces volume and results in a product that can be used as a fertilizer or soil amendment. Because dryers produce a 90 percent dry material, additional VAR is not required.

Digestion.

In ATAD (autothermal thermophilic aerobic digestion) systems, biosolids are heated to 131° F. to 140° F. (55° C. to 60° C.) and aerated for about 10 days. This autothermal process generates its own heat, and reduces volume. The result is a high-quality Class A product acceptable for reuse as a liquid fertilizer.

Pasteurization.

Pasteurization produces a Class A material when the biosolids are heated to at least 158° F. (70° C.) for 30 minutes. This extreme heat kills pathogens in the organic matter. When followed by anaerobic digestion, the VAR is attained and the biosolids can be land applied with minimal restrictions. The majority of the energy used in the pasteurization process is recovered with an innovative heat exchanger system and used to maintain the proper temperature in downstream anaerobic digesters.

The actual requirements for Class A Biosolids are spelled out in 40 CFR Part 503 issued in 1993, EPA entitled “Standards for the Use and Disposal of Sewage Sludge”. This rule defined the management practices and numerical criteria for the three major use and disposal options—land application, incineration and surface disposal. In addition to limiting where and when biosolids can be applied, the rule requires processes to kill pathogens and strictly limits amounts of metals that can be applied to any piece of land.

According to Siemen's, there is more to biosolids than achieving Class A or Class B status. Effective biosolids management systems feature efficient thickening, dewatering and transportation processes to reduce moisture and convey and store the dewatered “cake.” Without reliable thickening, dewatering and handling technologies, biosolids management would be a more difficult and expensive proposition.

Thickening.

To thicken or concentrate biosolids (in excess of 5 to 6 percent solids), Siemens Water Technologies offers a variety of systems, depending on biosolids characteristics and results desired. Among these are gravity belt and rotary drum thickeners, centrifuges, dissolved air flotation thickeners, and gravity thickeners.

Dewatering.

For dewatering, we provide belt presses and centrifuges, which are capable of producing biosolids cake of 25 to 35 percent solids. Siemen's line of filter presses can achieve solids levels as high as 45 percent. The J-Vap® system as well as direct and indirect drying systems can dry biosolids in excess of 90 percent solids.

Biosolids Handling.

Siemen's biosolids handling capabilities include belt conveyors, shafted and shaftless screw conveyors, and bucket elevators as well as a wide range of live bottom silos and hoppers for sludge collection and storage. They also provide biosolids mixing and pumping equipment.

The 40 CFR §503.13 Pollutant limits are as follows:

(a) Sewage Sludge.

(1) Bulk sewage sludge or sewage sludge sold or given away in a bag or other container shall not be applied to the land if the concentration of any pollutant in the sewage sludge exceeds the ceiling concentration for the pollutant in Table 1 of §503.13.

(2) If bulk sewage sludge is applied to agricultural land, forest, a public contact site, or a reclamation site, either:

(i) The cumulative loading rate for each pollutant shall not exceed the cumulative pollutant loading rate for the pollutant in Table 2 of §503.13; or

(ii) The concentration of each pollutant in the sewage sludge shall not exceed the concentration for the pollutant in Table 3 of §503.13.

(3) If bulk sewage sludge is applied to a lawn or a home garden, the concentration of each pollutant in the sewage sludge shall not exceed the concentration for the pollutant in Table 3 of §503.13.

(4) If sewage sludge is sold or given away in a bag or other container for application to the land, either:

(i) The concentration of each pollutant in the sewage sludge shall not exceed the concentration for the pollutant in Table 3 of §503.13; or

(ii) The product of the concentration of each pollutant in the sewage sludge and the annual whole sludge application rate for the sewage sludge shall not cause the annual pollutant loading rate for the pollutant in Table 4 of §503.13 to be exceeded. The procedure used to determine the annual whole sludge application rate is presented in appendix A of this part.

(b) Pollutant concentrations and loading rates—sewage sludge—(1) Ceiling concentrations.

Table 1 of §503.13 - Ceiling Concentrations

| Pollutant | Ceiling concentration (milligrams per kilogram)¹ |
|---|---|
| Arsenic | 75 |
| Cadmium | 85 |
| Copper | 4300 |
| Lead | 840 |
| Mercury | 57 |
| Molybdenum | 75 |
| Nickel | 420 |
| Selenium | 100 |
| Zinc | 7500 |

¹Dry weight basis.

(2) Cumulative pollutant loading rates.

Table 2 of §503.13 - Cumulative Pollutant Loading Rates

| Pollutant | Cumulative pollutant loading rate (kilograms per hectare) |
|---|---|
| Arsenic | 41 |
| Cadmium | 39 |
| Copper | 1500 |
| Lead | 300 |
| Mercury | 17 |
| Nickel | 420 |
| Selenium | 100 |
| Zinc | 2800 |

(3) Pollutant concentrations.

Table 3 of §503.13 - Pollutant Concentrations

| Pollutant | Monthly average concentration (milligrams per kilogram)¹ |
|---|---|
| Arsenic | 41 |
| Cadmium | 39 |
| Copper | 1500 |
| Lead | 300 |
| Mercury | 17 |
| Nickel | 420 |
| Selenium | 100 |
| Zinc | 2800 |

¹Dry weight basis.

(4) Annual pollutant loading rates.

Table 4 of §503.13 - Annual Pollutant Loading Rates

| | Annual pollutant loading rate |
|---|---|
| Pollutant | (kilograms per hectare per 365 day period) |
| Arsenic | 2.0 |
| Cadmium | 1.9 |
| Copper | 75 |
| Lead | 15 |
| Mercury | 0.85 |
| Nickel | 21 |
| Selenium | 5.0 |
| Zinc | 140 |

(c) Domestic septage. The annual application rate for domestic septage applied to agricultural land, forest, or a reclamation site shall not exceed the annual application rate calculated using equation (1).

$$A A R = \frac{N}{0.0026} \qquad Eq . ( 1 )$$

### Where:

AAR=Annual application rate in gallons per acre per 365 day period.
N=Amount of nitrogen in pounds per acre per 365 day period needed by the crop or vegetation grown on the land.
[58 FR 9387, Feb. 19, 1993, as amended at 58 FR 9099, Feb. 25, 1994; 60 FR 54769, Oct. 25, 1995]

§503.32 Pathogens.

(a) Sewage Sludge—Class A.

(1) The requirement in §503.32(a)(2) and the requirements in either §503.32(a)(3), (a)(4), (a)(5), (a)(6), (a)(7), or (a)(8) shall be met for a sewage sludge to be classified Class A with respect to pathogens. These standards vary based on time of application, type of land application for consumable crops vs. grasses and landscaping. Generally, current Class A regulations vary, but require fecal coliform in the sewage sludge be less than 1000 Most Probable Number (MPN) per gram of total solids (dry weight basis) or the density of Salmonella sp. Bacteria in the sewage sludge shall be less than 3 MPN at the time the sewage sludge is used or disposed or at the time the sewage sludge is prepared for sale or given away in a bag or other container for application to the land. The time of measurement thus varies, based on type and time of application, time of storage, temperature above 50 degrees Celsius or higher of the sewage sludge, percentage of solids above 7 percent, density of viable helminth ova, time exposed to air, etc.

When the density of viable helminth ova in the sewage sludge prior to pathogen treatment is equal to or greater than one per four grams of total solids (dry weight basis), the sewage sludge is Class A with respect to viable helminth ova when the density of viable helminth ova in the sewage sludge after pathogen treatment is less than one per four grams of total solids (dry weight basis).

Other methods to condition sewage sludge that is used or disposed shall be treated in a process that is equivalent to a Process to Further Reduce Pathogens, as determined by the permitting authority.

(b) Sewage Sludge—Class B.

(1)(i) The requirements in either §503.32(b)(2), (b)(3), or (b)(4) shall be met for a sewage sludge to be classified Class B with respect to pathogens.

(ii) The site restrictions in §503.32(b)(5) shall be met when sewage sludge that meets the Class B pathogen requirements in §503.32(b)(2), (b)(3), or (b)(4) is applied to the land.

These conventional Class A Biosolids treatment methods are generally energy intensive to achieve rapid disinfection, or take a long time for biodegradation. The chemical treatment method described below provides a low energy treatment method rapidly dewatering and disinfecting biomass producing few heavy metals, containing less than 10% water by weight, and biosolids with a BTU content approximating that of wood chips suitable for either land application or burning.

### SUMMARY OF THE INVENTION

The present method and apparatus is a chemical/mechanical wastewater treatment method for wastewater streams and/or conventional wastewater treatment plant process liquid streams containing suspended solids. It comprises removing all or a portion of the suspended solids in wastewater streams and/or conventional wastewater treatment plant process liquid streams entering a bioreactor forming a slurry filtrate with reduced solids and BOD to reduce the load on the bioreactor, but with sufficient dissolved and suspended solids suitable to support bacteria and microbe bioreduction of nitrogen, phosphorous, BOD, and other nutrients.

SO₂ is then injected into the suspended solids at a pH and dwell time to generate sufficient sulfurous acid with free SO₂, sulfites and bisulfites to:

i. disinfect and self-agglomerate the suspended solids,

ii. acid leach heavy metals contained in and on the suspended solids into solution for subsequent removal and separation, and

iii. condition the suspended solids for subsequent dewatering by shedding water upon separation and drying.

The SO2 treated solids fraction is then separated from the liquid fraction using mechanical separators, clarifiers, etc.

The liquid fraction is then transferred into the bioreactor for bioremediation to remove nitrogen, phosphorous, and nutrients to the degree required to meet wastewater treatment plant discharge requirements for land application or open stream discharge

The solids fraction is then allowed to dry to create a disinfected, reduced metal biosolid with less than 10% by weight water with BTU content comparable to wood.

In another variation, the method comprises diverting all or a portion of wastewater streams and/or conventional wastewater treatment plant process liquid streams entering a bioreactor for chemical pre-treatment.

SO₂ is injected into the diverted portion at a pH and dwell time to generate sufficient sulfurous acid with free SO₂, sulfites and bisulfites to:

i. disinfect and self-agglomerate the suspended solids,

ii. acid leach heavy metals contained in and on the suspended solids into solution for subsequent removal and separation, and

iii. condition the suspended solids for subsequent dewatering by shedding water upon separation and drying.

Usually SO2 is produced on-site with a sulfur burner and injected at a pH held between approximately 1.5 and 4.5, depending upon dwell time required for disinfection. For example, dwell time at pH 2 is 10 minutes; whereas at pH 4.5, it may require day's storage.

Next, all or a portion of the suspended solids are removed from the diverted portion of the wastewater streams and/or conventional wastewater treatment plant process liquid streams forming a slurry filtrate with reduced solids and BOD to reduce the load on bioreactors. The extent of solids removal varies and is dependent upon the type of bioreactor and the type of bacteria and microbes and their temperature sensitivity. Consequently, removal rates may be adjusted periodically to leave sufficient dissolved and suspended solids suitable to support bacteria and microbe bioreduction of nitrogen, phosphorous, BOD, and other nutrients to meet a wastewater treatment plant's discharge requirements. Usually this is done by a variable flow splitter, which is adjusted to insure sufficient solids are directed into the bioreactor to sustain microbe and bacteria metabolism.

The SO₂ injected slurry filtrate is then mechanically separated into a solids fraction and a slurry fraction.

The slurry fraction is then transported back to the bioreactor for bioremediation to remove nitrogen, phosphorous, BOD, and nutrients to the degree required to meet wastewater treatment plant discharge requirements for land application or open stream discharge.

The solids fraction is then allowed to chemically drain and dewater to create a disinfected, reduced metal biosolid with less than 10% by weight water with BTU content comparable to wood.

Preferably the heavy metals in solution are removed via alkalization precipitation, leaving acid leached biosolids meeting Class A biosolids standards upon drying. A recent test of the biosolids treated and separated with the present method at the Montalvo Municipal Improvement District showed fecal coliforms of 187 MPN/gram, dry, with a heating value of 6,932 BTU/lb with 7% moisture by weight. The heavy metals concentrations compared to the Table 3 monthly average §503.13 standards were:

| Arsenic | ND/41 |
|---|---|
| Cadmium | ND/39 |
| Copper | 637/1500 |
| Lead | 6.4/300 |
| Mercury | 0.36/17 |
| Nickel | 4.8/420 |
| Selenium | 6.5/100 |
| Zinc | 68/2800 |

Thus, this Montalvo treated biosolids met both the Rule 503 disinfection standards of 1000 MPN, and the heavy metals standards shown above.

If disinfection is not sufficient to meet the Class A biosolids standards, the biosolids may be exposed to chemical oxidizing agents, such as peroxide, ozone, Fenton's reagent, chlorine, hypochlorites, etc., heat, ultraviolet light, pasteurization, composting and other disinfection means to further disinfect them.

Because of the cost, the heavy metals are preferably removed with hydrated or anhydrous lime used to precipitate them as metal hydroxides for removal.

Any number of mechanical configurations and devices may be used to implement this chemical/mechanical sludge dewatering treatment method. These usually involve:

A. means for diverting all or a portion of wastewater streams and/or conventional wastewater treatment plant process liquid streams entering a bioreactor, such as pumps, splitters, valves, and combinations thereof. Preferably, variable flow valving system is used to allow different flows to be diverted during the year to insure that sufficient solids enter the bioreactors at different flow rates and temperatures to maintain their bioremediation requirements.

B. tanks of sulfur dioxide, sulfur generators, and other means for injecting SO₂ into the diverted portion of wastewater streams and/or conventional wastewater treatment plant process liquid streams are included at a pH and dwell time to generate sufficient sulfurous acid with free SO₂, sulfites and bisulfites to:

i. disinfect and self-agglomerate the suspended solids,

ii. acid leach heavy metals contained in and on the suspended solids into solution for subsequent removal and separation, and

iii. condition the suspended solids for subsequent dewatering by shedding water upon separation and drying.

C. means for removing all or a portion of the suspended solids from the diverted portion of the wastewater streams and/or conventional wastewater treatment plant process liquid streams forming a slurry filtrate with reduced solids and BOD to reduce the load on bioreactors, but with sufficient dissolved and suspended solids suitable to support bacteria and microbe bioreduction of nitrogen, phosphorous, BOD, and other nutrients.

D. means for mechanically separating the SO2 injected slurry filtrate into a solids fraction and a slurry fraction,

E. means for conveying the slurry fraction in the bioreactor for bioremediation to remove nitrogen, phosphorous, and nutrients to the degree required to meet wastewater treatment plant discharge requirements for land application or open stream discharge, and

F. means for drying the solids fraction to create a disinfected, reduced metal biosolids with less than 10% by weight water with BTU content comparable to wood.

Preferably the separated chemically treated solids are land filled, gasified, or burned.

The preferred means for removal of heavy metals from the chemically treated liquid fraction is via alkalization precipitation to precipitate heavy metals as metal hydroxides and phosphates as calcium and ammonium phosphate for removal. Calcium or potassium hydroxide may be used with the liquid solutions to precipitate heavy metals for removal producing a demetalized chemically treated water for land application or addition to mechanically separated wastewater streams to dilute its heavy metal content. Ammonium hydroxide not only precipitates the metal hydroxides, but adds nitrogen to raise crops if required for land application

Preferably, the hydrated SO₂ is produced on site as needed by passing the inflow streams and/or conventional process liquid streams through a sulfurous acid generator.

Chemical treatment of biosolids with sulfurous acid reduces pathogens through bisulfite and sulfite kill, while simultaneously acid leaching heavy metals from the solids into solution for subsequent liming removal. Field tests, such as those discussed, have shown that this chemical pre-treatment results in biosolids with reduced heavy metals meeting either §503.32(a)(3), (a)(4), (a)(5), (a)(6), (a)(7), or (a)(8) and §503.13 heavy metals standards and having less than 10% water content; thus producing biosolids with BTU content approximating that of wood chips suitable for either land application or burning. Class A pathogen standards are generally met via SO₂ addition alone. However, if further disinfection is required, the type of disinfection method is dependent upon whether chemical, heat, ultraviolet, composting, or organic methods are preferred.

For example, vermicompost may be preferred as opposed to using traditional composting methods for the management of organic wastes. Vermiprocessing produces a usable product in less time using worms producing worm castings with greater soil value than aerobic composts. Salmonella, fecal coliform, enteric (intestinal) viruses, and helminthes ova (parasitic worm eggs) are pathogenic organisms present in the sludge composting. While all of these pathogens are present in soils, they can be concentrated in composting and vermicomposting.

As discussed above, traditional aerobic composting reduces pathogen levels by elevating temperatures between 135-160 degrees F. for sufficient time for pathogen destruction to produce Class A compost suitable for use in areas where the public might come in contact with the compost product. Conversely, vermicomposting is managed to ensure temperatures in the organic material remain below 90 degrees F. to support high levels of earthworm activity, which many assumed would not kill pathogens. Bruce Eastman, the Assistant Manager with the Orange County Environmental Protection Agency, found to the contrary. In his article “The Effectiveness of Vermiculture in Human Pathogen Reduction for USEPA Biosolids Stabilization”, Compose Science & Utilization, (2001), Vol. 9, No. 1, 38-49, a study done by the partnership of the Orange County Environmental Protection Division, American Earthworm Company and the city of Ocoee Fla. demonstrate a cost effective means of vermicomposting human biosolids to produce a finished product that could be classified as a class A compost product.

The Orange County research team was required to demonstrate that vermicomposting of biosolids that had been “spiked” with abnormally high concentrations of pathogenic organisms could accomplish a three to four fold reduction in pathogen numbers. The team conducted their tests in two parts; the first in two windrows fed biosolids (15-20% solids) spiked with salmonella, fecal coliforms and enteric viruses, and the second in two windrows fed biosolids (15-20% solids) spiked with helminthes ova. The helminthes test was done separately due to difficulty in obtaining helminthes ova eggs. In each of the tests Eisenia fetida worms were inoculated into one of the windrows, the other being used as a control to measure the pathogen decline rate in the absence of earthworm activity. Samples were taken from random points along the windrows and analyzed throughout the test period.

The research demonstrated that all pathogen levels in the test rows were reduced to a significantly lower level than in the control rows and met the EPA goal within 144 hours. Fecal coliforms achieved the EPA required three to four fold reduction in 24 hours, salmonella and enteric virus reductions were achieved in 72 hours and helminthes ova levels met the EPA goal in 144 hours. It's believed the helminthes levels took longer to be reduced because the worms were inoculated into the helminthes spiked windrows in a substrate of peat moss. The researchers believe the worms remained in the peat for several hours before moving into the biosolids, thus increasing the time for helminthes reduction. The test demonstrated pathogen reduction meeting EPA requirements using only vermicomposting.

The present method thus removes all or a portion of the suspended solids in wastewater streams and/or conventional wastewater treatment plant process liquid streams to expand the capacity of bioreactors by reducing bioreactor loads, and produces Class A biosolids using SO₂ for disinfection and self-agglomeration of suspended solids, acid leaching heavy metals contained in and on the suspended solids into solution for subsequent removal and separation, and conditioning the suspended solids for subsequent dewatering by shedding water upon separation and drying.

The biosolids, when dry, create a disinfected, reduced metal biosolid with less than 10% by weight water with a BTU content comparable to wood.

### DESCRIPTION OF THE DRAWINGS

FIG. 1 illustrates a retrofit of the Jerome, Id. plant diagram and solids flow.

FIG. 2 illustrates the modeling set up of wastewater influent entering two BioTower tricking filters.

FIG. 3 is a computer model graph of 3.2 MGD containing 333 mg/L TSS and 600 gCOD/m3.

FIG. 4 is a computer model graph of 3.2 MGD containing reduced organic suspended solids of 55.6 mg/L TSS and 100 gCOD/m3.

### DESCRIPTION OF THE ILLUSTRATED EMBODIMENTS

An example of the present invention will be best understood by reference to the drawings. The components, as generally described and illustrated, could be arranged and designed in a wide variety of different configurations. Thus, the description of the embodiments is not intended to limit the scope of the invention, as claimed, but is merely representative of presently preferred embodiments of the invention.

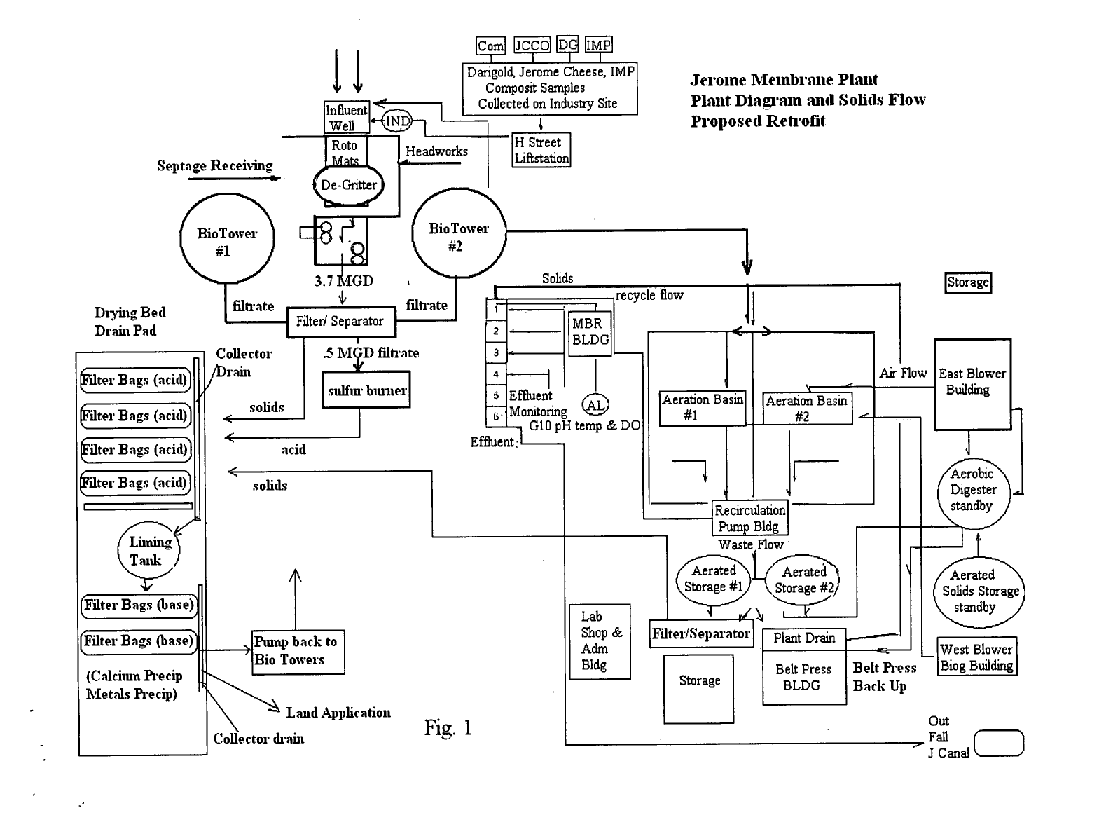

FIG. 1 illustrates a retrofit of the Jerome, Id. plant diagram and solids flow. 3.7 MGD wastewater influent 10 enters de-gritters 12 at the headworks before entering two BioTower tricking filters 14 for nitrogen, phosphorous and BOD removal. The invention retrofit shows how the organic TSS are removed via a Filter/Separator 16 after the inorganic suspended solids were first removed by the roto mat degritters 12. This removal reduces the carbon rich suspended solids affecting bioreactor load (two-thirds of the Jerome influent is from dairy and milk operations containing high carbon/fat content) by diverting them for removal and chemical dewatering in a geotextile bags 18 as shown in the schematic.

Specifically, the screened influent 10 after the De-Gritter 12 is diverted via a filter/separator 16 that sends slurried solids to geotextile bags 18 placed on a drain pad 20 for chemical dewatering, with the majority of the filtrate going back through the Bio Towers 14. A portion of the filtrate (˜0.5 MGD is passed through a sulfur burner 22 to produce sulfurous acid for acid injection into the geotextile bags 18 along with the separated solids at a pH of 3.5 to disinfect and chemically dewater the same forming chemically dewatered biosolids having less than 10% by weight water content. Chemical dewatering reduces the volume and the weight for sludge hauling and disposal. In addition, at a pH below 4.7, dissolved fat and protein solids from the dairy and cheese wastewater in the filtrate curdles and separates for bag filtration removal; see “Isolation of Casein, Lactose, and Albumin from Milk”, adapted by R. Minard (Penn State Univ.) from Introduction to Organic Laboratory Techniques: A Microscale Approach, Pavia, Lampman, Friz & Engel, Sanders, 1990. Revised Mar. 20, 2000, which would further reduce BOD.

The filtrate from the geotextile bags 18 is collected on the drain Pad 20 and sent to a liming tank where lime raises the filtrate pH and precipitates dissolved heavy metals in the influent 10 as metal hydroxides and phosphorous as calcium phosphate, which are filtered by a second set of geotextile bags 26 (Typically, phosphorous is reduced 40% to 50%). The pH adjusted filtrate after heavy metals and phosphorous removal is then sent back to the BioTowers 14 for nitrogen and BOD removal.

These chemically dewatered biosolids have a BTU content ˜6000 BTU/lb comparable to wood and are very dry. The geotextile bags 18, 26 contain odors and can also be burned in a municipal burner along with the dewatered solids. As the water content of these separated solids is substantially less than those produced by the present belt press, haulage and landfill charges should be proportionately reduced as discussed below.

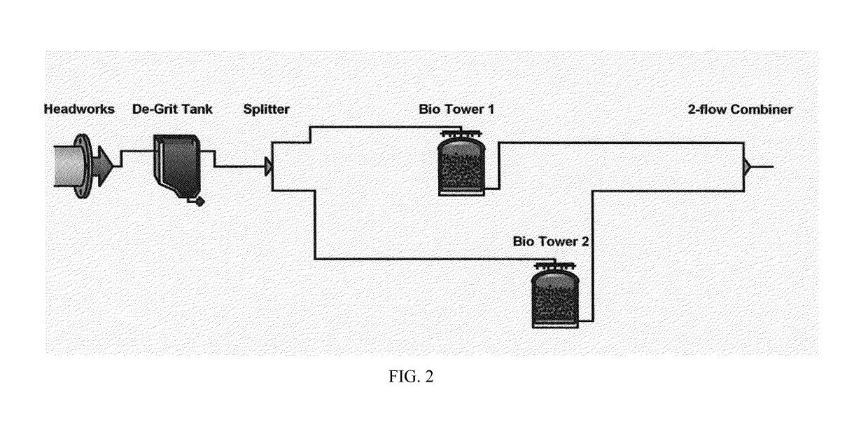

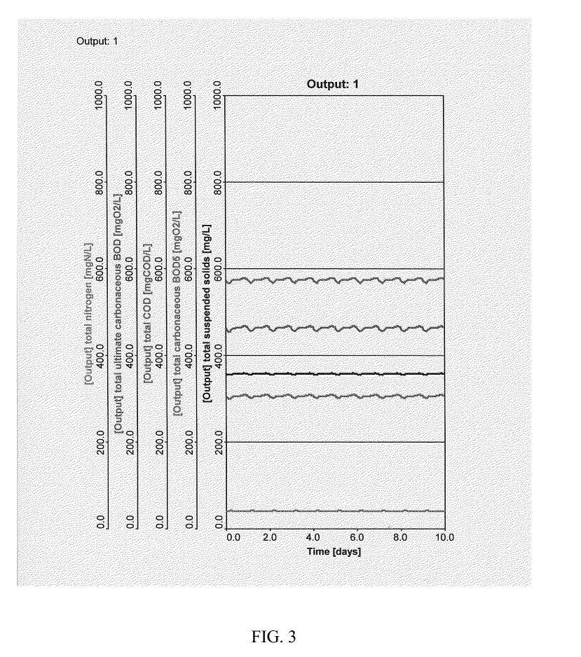

The impact of reducing suspended solids on the bioreactor processing capacity is dependent upon their carbonaceous content. Carbonaceous suspended solids materially impact BOD and COD. As a rule of thumb BOD comprises 40-60 of the TSS, according to Kemira, www.kemira.com/en/solutionsproducts/municipalwater/wastewat. To computer model BOD reduction, Hydromantis GPS-X 6.1 computer modeling of two trickling filters receiving reduced inorganic grit removed filtrate was performed as shown in FIGS. 2 and 3.

FIG. 2 illustrates a computer modeling set up of wastewater influent entering two BioTower tricking filters 14 similar to the ones at the 3.7 MGD Jerome, Id. wastewater treatment facility. To calculate the increase in the BioTower capacity, the total organic suspended solids (TSS) were removed from 3.2 MGD of the influent undergoing biological reduction to reduce the load on these bioreactors 14.

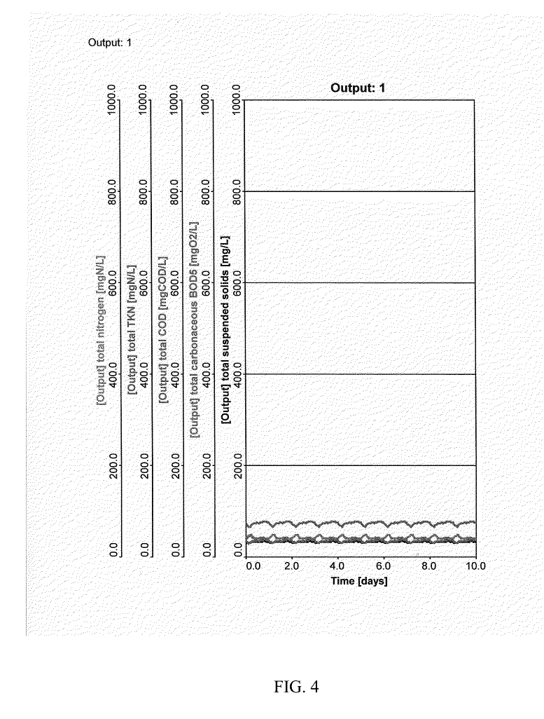

First, 3.2 MGD containing 333 mg/L TSS and 600 gCOD/m3 was modeled with the results summarized in the graph shown in FIG. 3. This high organic suspended solids run was then compared to a 5.0 MGD model run with reduced organic suspended solids of 55.6 mg/L TSS and 100 gCOD/m3 summarized in the graph shown in FIG. 4.

Computer modeling thus suggests that organic TSS removal before biological reduction significantly increases the capacity of the Bio Towers 14 to reduce BOD and nitrogen. As computer modeling of actual biological system performance is difficult to predict due to temperature, influent composition fluctuations, and microbe and bacteria concentrations and compositions, actual results vary. However, as the cost for carbonaceous suspended solids removal is considerably less than installing additional bioreactors, by implementing suspended solids removal first improves Bio Tower 14 performance. If the actual biological removal of nitrogen and BOD results are not sufficient, an additional 0.5 to or 1 MGD Biobrimstone® chemical/biological treatment modules may then be installed.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. A chemical/mechanical wastewater treatment method for wastewater streams and/or conventional wastewater treatment plant process liquid streams containing suspended solids comprising:
a. removing all or a portion of the suspended solids in wastewater streams and/or conventional wastewater treatment plant process liquid streams entering a bioreactor forming a slurry filtrate with reduced solids and BOD to reduce the load on the bioreactor, but with sufficient dissolved and suspended solids suitable to support bacteria and microbe bioreduction of nitrogen, phosphorous, BOD, and other nutrients,
b. injecting SO₂ into the suspended solids at a pH and dwell time to generate sufficient sulfurous acid with free SO₂, sulfites and bisulfites to:
i. disinfect and self-agglomerate the suspended solids,
ii. acid leach heavy metals contained in and on the suspended solids into solution for subsequent removal and separation,
iii. condition the suspended solids for subsequent dewatering by shedding water upon separation and drying,
c. mechanically separating the SO2 treated solids fraction from the liquid fraction,
d. transferring the liquid fraction for land application or into a bioreactor for bioremediation to remove nitrogen, phosphorous, and nutrients to the degree required to meet wastewater treatment plant discharge requirements, and
e. drying the solids fraction to create a disinfected, reduced metal biosolid with less than 10% by weight water with a BTU content comparable to wood.

2. The chemical/mechanical sludge dewatering treatment method according to claim 1, wherein the heavy metals in solution are removed via alkalization precipitation, leaving biosolids meeting Class A biosolids standards upon drying.

3. The chemical/mechanical sludge dewatering treatment method according to claim 1, including exposing the biosolids to oxidizing agents, heat, ultraviolet light, pasteurization, composting and other disinfection means to further disinfect them if required to meet Class A biosolids disinfection standards.

4. The chemical/mechanical sludge dewatering treatment method according to claim 1, wherein the disinfected, reduced metal biosolids are land filled, gasified, or burned.

5. The chemical/mechanical sludge dewatering treatment method according to claim 1, wherein hydrated or anhydrous lime is used to precipitate heavy metals for removal.

6. The chemical/mechanical sludge dewatering treatment method according to claim 1, wherein the pH is held between approximately 1.5 and 4.5, depending upon dwell time required for disinfection.

7. A chemical/mechanical wastewater treatment method for wastewater streams and/or conventional wastewater treatment plant process liquid streams containing suspended solids comprising:
a. diverting all or a portion of wastewater streams and/or conventional wastewater treatment plant process liquid streams entering a bioreactor,
b. injecting SO₂ into the diverted portion at a pH and dwell time to generate sufficient sulfurous acid with free SO₂, sulfites and bisulfites to:
i. disinfect and self-agglomerate the suspended solids,
ii. acid leach heavy metals contained in and on the suspended solids into solution for subsequent removal and separation,
iii. condition the suspended solids for subsequent dewatering by shedding water upon separation and drying,
c. removing all or a portion of the suspended solids from the diverted portion of the wastewater streams and/or conventional wastewater treatment plant process liquid streams forming a slurry filtrate with reduced solids and BOD to reduce the load on bioreactors, but with sufficient dissolved and suspended solids suitable to support bacteria and microbe bioreduction of nitrogen, phosphorous, BOD, and other nutrients,
d. mechanically separating the SO2 injected slurry filtrate into a solids fraction and a slurry fraction,
e. injecting the slurry fraction into the bioreactor for bioremediation to remove nitrogen, phosphorous, and nutrients to the degree required to meet wastewater treatment plant discharge requirements for land application or open stream discharge, and
f. drying the solids fraction to create a disinfected, reduced metal biosolid with less than 10% by weight water with a BTU content comparable to wood.

8. A chemical/mechanical sludge dewatering treatment apparatus comprising:
a. means for diverting all or a portion of wastewater streams and/or conventional wastewater treatment plant process liquid streams entering a bioreactor,
b. means for injecting SO₂ into the diverted portion at a pH and dwell time to generate sufficient sulfurous acid with free SO₂, sulfites and bisulfites to:
i. disinfect and self-agglomerate the suspended solids,
ii. acid leach heavy metals contained in and on the suspended solids into solution for subsequent removal and separation,
iii. condition the suspended solids for subsequent dewatering by shedding water upon separation and drying,
c. means for removing all or a portion of the suspended solids from the diverted portion of the wastewater streams and/or conventional wastewater treatment plant process liquid streams forming a slurry filtrate with reduced solids and BOD to reduce the load on bioreactors, but with sufficient dissolved and suspended solids suitable to support bacteria and microbe bioreduction of nitrogen, phosphorous, BOD, and other nutrients,
d. means for mechanically separating the SO2 injected slurry filtrate into a solids fraction and a slurry fraction,
e. means for injecting the slurry fraction in the bioreactor for bioremediation to remove nitrogen, phosphorous, and nutrients to the degree required to meet wastewater treatment plant discharge requirements for land application or open stream discharge, and
f means for drying the solids fraction to create a disinfected, reduced metal biosolid with less than 10% by weight water with a BTU content comparable to wood.

9. The chemical/mechanical sludge dewatering treatment apparatus according to claim 8, wherein the separated chemically treated solids are land filled, gasified, or burned.

10. The chemical/mechanical sludge dewatering treatment apparatus according to claim 8, including means for removal of heavy metals from the chemically treated liquid fraction via alkalization precipitation to precipitate heavy metals and phosphates for removal.

11. The chemical/mechanical sludge dewatering treatment apparatus according to claim 10, wherein calcium or potassium hydroxide is used with the liquid solution to precipitate heavy metals for removal producing a demetalized chemically treated water for land application or addition to mechanically separated wastewater streams to dilute its heavy metal content.

12. The chemical/mechanical sludge dewatering treatment apparatus according to claim 8, wherein the means for chemically treating the diverted portion of the wastewater inflow steams with hydrated SO2 comprises passing the inflow streams and/or conventional process liquid streams through a sulfurous acid generator.
